(19) United States
(12) Patent Application Publication
(10) Pub. No.: US 2006/0215344 A1
(43) Pub. Date: Sep. 28, 2006

(54) Electrostatic protection device for semiconductor device

(76) Inventor: Nak Heon Choi, Kyoungki-do (KR)

Correspondence Address: LADAS & PARRY LLP, 224 SOUTH MICHIGAN AVENUE, SUITE 1600, CHICAGO, IL, 60604, US

(21) Appl. No.: 11/373,950

(22) Filed: Mar. 13, 2006

(30) Foreign Application Priority Data
Mar. 11, 2005 (KR) 10-2005-0020489
Mar. 10, 2006 (KR) 10-2006-0022685

(51) Int. Cl. H02H 7/20

(52) U.S. Cl. 361/112

(57) ABSTRACT

Disclosed is an electrostatic protection device for a semiconductor device. The electrostatic protection device includes a transfer unit for transferring static electricity introduced through an input/output port to an external voltage line and outputting a first voltage caused by the static electricity, a driver connected between the first voltage and a grounding voltage line, and a discharge unit connected between the external voltage line and the grounding voltage line so as to be driven based on the output of the driver, wherein the driver is turned on by the static electricity transferred to the external voltage line.

### BACKGROUND OF THE INVENTION

1. Field of the invention

The present invention relates to an electrostatic protection device for a semiconductor device, and more particularly to an electrostatic protection device for a semiconductor device, which, protects a semiconductor integrated circuit from being damaged by electrostatic discharge (ESD).

2. Description of the Prior Art

As generally known in the art, electrostatic discharge (ESD) is one of main factors affecting the reliability of a semiconductor chip, and may cause damage to a semiconductor chip.

That is, when an electrically charged human body or machine makes contact with a semiconductor chip, static electricity in the human body or the machine may be discharged into an internal circuit of the semiconductor chip through the external pins thereof or the internal input/output ports thereof, so that excessive electrostatic current having high energy may inflict severe damage on the internal circuit of the semiconductor chip.

Therefore, most semiconductor chips necessarily include an electrostatic protection device in a data input/output region in order to prevent the semiconductor chip from being damaged by the static electricity.

Meanwhile, as the technique for manufacturing a semiconductor device becomes developed, the thickness of a gate insulating layer of a transistor included in an input/output buffer is further reduced, so that the internal circuit of the semiconductor device may be more easily damaged due to static electricity. In other words, if the thickness of the gate insulating layer of the transistor is reduced, a threshold voltage destroying the gate insulating layer becomes lowered. Thus, if a conventional electrostatic protection device is used, the gate insulating layer of the transistor included in the internal circuit may be destroyed even if relatively lower static electricity is applied thereto.

In order to solve such a problem, an electrostatic protection device for a semiconductor device as shown in FIG. 1 has been used.

The circuit shown in FIG. 1 includes a transfer unit 11, a control unit 12, a driver 13, and a discharge unit 14. The transfer unit 11 transfers static electricity, which is introduced into the semiconductor device through an input/output port 15, to an external voltage (Vcc) line 17 instead of an internal circuit 16. Such static electricity transferred to the external voltage (Vcc) line 17 is transferred to the control unit 12, the driver 13, and the discharge unit 14.

The control unit 12 includes a resistor R1 and a capacitor C1 serially connected between the external voltage (Vcc) line 17 and a grounding voltage (Vss) line 18. The driver 13 includes a CMOS type buffer which contains a PMOS transistor P1 and an NMOS transistor N1 serially connected between the external voltage (Vcc) line 17 and the grounding voltage (Vss) line 18. The discharge unit 14 includes an NMOS transistor N2 connected between the external voltage (Vcc) line 17 and the grounding voltage (Vss) line 18.

Referring to FIG. 1, static electricity is transferred to the control unit 12 via the external voltage (Vcc) line 17 by means of the transfer unit 11. When the static electricity is introduced into the control unit 12, a voltage drop is caused at a node located between the resistor R1 and the capacitor C1, so that the PMOS transistor P1 of the driver 13 is turned on due to the voltage drop. As a result, the NMOS transistor N2 of the discharge unit 14 is turned on, so that the external voltage (Vcc) line 17 is connected to the grounding voltage (Vss) line 18. Accordingly, the static electricity transferred to the external voltage (Vcc) line 17 is discharged through the grounding voltage (Vss) line 18.

In other words, static electricity introduced into the input/output port 15 is transferred to the external voltage (Vcc) line 17 by the transfer unit 11 and then discharged through the grounding voltage (Vss) line 18 via the NMOS transistor N2. Accordingly, the electrostatic protection device protects the internal circuit 16 of the semiconductor device from static electricity introduced through the input/output port 15.

In the circuit of FIG. 1, a voltage drop is swiftly generated during a rising interval of static electricity owing to the operational characteristics of the capacitor C1, so that the circuit has a fast operational response speed against static electricity. However, since the voltage drop of the control unit 12 occurs only during the rising interval of static electricity, the driver 13 operates only during the rising interval so as to discharge the static electricity. As a result, the internal circuit of the semiconductor device is not protected from being damaged by static electricity during intervals (e.g., a peak interval and a falling interval) following the rising interval of the static electricity.

FIG. 2 is a circuit view illustrating “an electrostatic protection device for a semiconductor device” filed in the Korean Intellectual Property Office on Dec. 28, 2004 by applicant of the present invention and assigned Patent Application Serial No. 2004-114210.

The electrostatic protection device for a semiconductor device shown in FIG. 2 includes a transfer unit 21, a detection unit 22, a driver 23, and a discharge unit 24.

The transfer unit 21 includes diodes serially connected between an external voltage (Vcc) line 27 and a grounding voltage (Vss) line 28. The transfer unit 21 transfers static electricity, which is introduced through an input/output port 25, to the external voltage (Vcc) line 27.

The detection unit 22 includes a resistor R4 and a diode D3 serially connected between the external voltage (Vcc) line 27 and an input port of an internal circuit 26. The detection unit 22 detects the static electricity transferred to the external voltage (Vcc) line 27 and applies a detection voltage to the driver 23. The detection voltage is a voltage of a common connection port of the resistor R4 and the diode D3, and is applied to the driver 23.

The driver 23 includes a PMOS transistor P2 and an NMOS transistor N3 serially connected between an output port of the detection unit 22 and the grounding voltage (Vss) line 28. In other words, the driver 23 includes a CMOS type buffer containing the PMOS transistor P2 and the NMOS transistor N3. The detection voltage inputted from the detection unit 22 is applied to a source port of the PMOS transistor (P2), and the driver 23 is driven by the detection voltage. That is, the detection voltage inputted from the detection unit 22 serves as a supply voltage of the CMOS type buffer. When the CMOS type buffer operates based on the detection voltage, the static electricity transferred to the external voltage (Vcc) line 27 is applied to the input ports of the CMOS type buffer, that is, gate ports of the PMOS transistor P2 and the NMOS transistor N3. Accordingly, the driver 23 operates the discharge unit 24.

The discharge unit 24 includes an NMOS transistor N4 connected between the external voltage (Vcc) line 27 and the grounding voltage (Vss) line 28. A drain port of the NMOS transistor N4 is connected to the external voltage (Vcc) line 27, and a source port of the NMOS transistor N4 is connected to the grounding voltage (Vss) line 28.

The electrostatic protection device for a semiconductor device shown in FIG. 2 transfers static electricity, which has been introduced through the input/output port 25, to the external voltage (Vcc) line 27 through the transfer unit 21, and detects the static electricity transferred to the external voltage (Vcc) line 27 by means of the detection unit 22. In addition, the detection unit 22 applies a detection voltage to the driver 23 in response to the static electricity. When the driver 23 operates in response to the static electricity, the static electricity transferred to the external voltage (Vcc) line 27 is discharged through the grounding voltage (Vss) line 28 via the discharge unit 24.

As compared with the electrostatic protection device for a semiconductor device shown in FIG. 1, the electrostatic protection device for a semiconductor device of FIG. 2 can improve the operational characteristics during intervals (e.g., a peak interval and a falling interval) following a rising interval of static electricity. However, when a semiconductor chip normally operates, the diodes of the transfer unit 21 and the diode D3 of the detection unit 22 serve as a parallel capacitor in view of the input/output port 25. Therefore, there is a difficulty to use the circuit of FIG. 2 for semiconductor devices requiring a small capacitance for a fast operational characteristic.

### SUMMARY OF THE INVENTION

Accordingly, the present invention has been made to solve the above-mentioned problems occurring in the prior art, and an object of the present invention is to provide an electrostatic protection device for a semiconductor device which can operate a discharge circuit during the entire interval where static electricity occurs, and reduce a capacitance in view of an input/output port, thereby being advantageously applied to a high-speed semiconductor chip.

In order to accomplish this object, there is provided an electrostatic protection device for a semiconductor device which protects a semiconductor integrated circuit from being damaged by electrostatic discharge introduced through an input/output port, the electrostatic protection device comprising: a transfer unit for transferring static electricity introduced through the input/output port to an external voltage line, and outputting a voltage applied at a first node used for transferring the static electricity as a detection voltage; a first driver connected between a grounding voltage line and the first node, from which the detection voltage is outputted, operated based on the static electricity transferred to the external voltage line, and driven by means of the detection voltage; and a first discharge unit driven based on the output of the first driver in order to discharge the static electricity, which has been transferred to the external voltage line, to the grounding voltage line.

Preferably, the transfer unit includes a plurality of diodes serially connected between the external voltage line and the grounding voltage line, in which the diodes are arranged such that anodes of the diodes point to the grounding voltage line, while cathodes of the diodes point to the external voltage line.

Preferably, the transfer unit includes a second node connected to the input/output port, and the detection voltage is controlled by the number of diodes connected between the external voltage line and the first node which is located between the second node and the external voltage line.

Preferably, the first driver includes a PMOS transistor and an NMOS transistor serially connected between the first node and the grounding voltage line, and a common gate of the PMOS transistor and the NMOS transistor is connected to the external voltage line.

More preferably, the electrostatic protection device further comprises a control unit, a second driver, and a second discharge unit, which are connected in parallel between the external voltage line and the grounding voltage line, wherein a voltage drop corresponding to an initial alternating current characteristic of the static electricity occurs in the control unit; the second driver operates based on the static electricity transferred to the external voltage line and is driven by means of the voltage drop in the control unit; and the second discharge unit is driven by means of driving voltage of the second driver so as to discharge the static electricity to the grounding voltage line in response to an initial interval of the static electricity at which the static electricity has an alternating current characteristic.

Preferably, the control unit includes a resistor and a capacitor which are connected serially to each other.

Preferably, the second driver includes a PMOS transistor and an NMOS transistor serially connected between the external voltage line and the grounding voltage line, and a common gate of the PMOS transistor and the NMOS transistor is connected to the external voltage line.

### BRIEF DESCRIPTION OF THE DRAWINGS

The above and other objects, features and advantages of the present invention will be more apparent from the following detailed description taken in conjunction with the accompanying drawings, in which:

FIG. 1 is a circuit view illustrating an example of a conventional electrostatic protection device for a semiconductor device;

FIG. 2 is a circuit view illustrating another example of a conventional electrostatic protection device for a semiconductor device;

FIG. 3 is a circuit view illustrating an electrostatic protection device for a semiconductor device according to a first embodiment of the present invention;

FIG. 4 is a circuit view illustrating an electrostatic protection device for a semiconductor device according to a second embodiment of the present invention;

FIG. 5 is a circuit view illustrating an electrostatic protection device for a semiconductor device according to a third embodiment of the present invention; and

FIG. 6 is a circuit view illustrating an electrostatic protection device for a semiconductor device according to a fourth embodiment of the present invention.

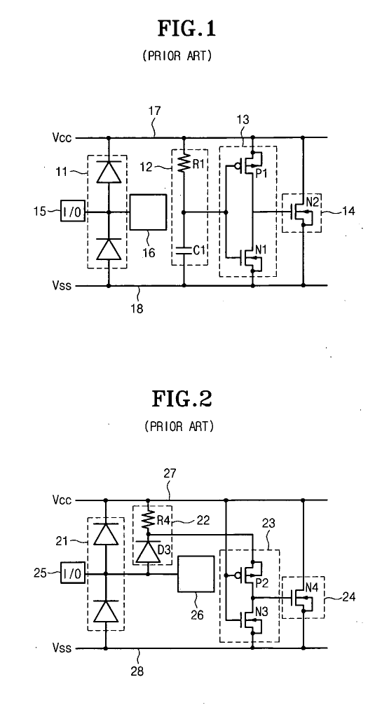

### DETAILED DESCRIPTION OF THE PREFERRED EMBODIMENTS

Hereinafter, preferred embodiments of the present invention will be described with reference to the accompanying drawings. In the following description and drawings, the same reference numerals are used to designate the same or similar components, so repetition of the description on the same or similar components will be omitted.

The electrostatic protection device according to the present invention includes a transfer unit for outputting a detection voltage.

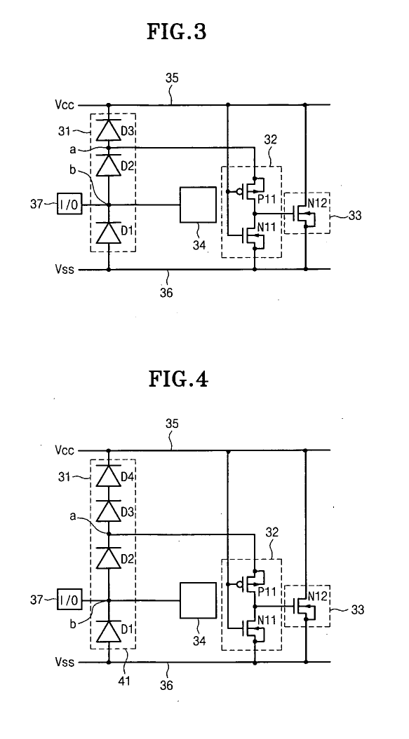

Referring to FIG. 3, the circuit according to an embodiment of the present invention includes a transfer unit 31, a driver 32, and a discharge unit 33.

The transfer unit 31 includes diodes D1, D2 and D3, which are serially connected between an external voltage (Vcc) line 35 and a grounding voltage (Vss) line 36. The diodes D1, D2 and D3 are serially connected in such a manner that the cathodes thereof point to the external voltage (Vcc) line 35, while the anodes thereof point to the grounding voltage (Vss) line 36. The transfer unit 31 transfers static electricity, which has been introduced through an input/output port 37, to the external voltage (Vcc) line 35 in order to prevent the static electricity from being introduced into an internal circuit 34. A detection voltage is generated at an intermediate node “a” between the diodes D2 and D3 in response to a direct current component of static electricity applied through the input/output port 37, and the detection voltage serves as the driving voltage of the driver 32.

The inverter-type driver 32 includes a PMOS transistor P11 and an NMOS transistor N11 which are serially connected between the node “a” and the grounding voltage (Vss) line 36, and a common gate of the PMOS transistor P11 and the NMOS transistor N11 is connected to the external voltage (Vcc) line 35.

Since the detection voltage of the node “a” in the transfer unit 31 is applied to the source port of the PMOS transistor P11, it can be understood that the detection voltage serves as the driving voltage of the driver 32.

The static electricity transferred to the external voltage (Vcc) line 35 is applied to an input port of the driver 32, that is, to the common gate port of the PMOS transistor P11 and the NMOS transistor N11. Accordingly, the PMOS transistor P11 is turned on, thereby turning on the discharge unit 33 described later.

The discharge unit 33 includes an NMOS transistor N12 connected between the external voltage (Vcc) line 35 and the grounding voltage (Vss) line 36. In detail, the drain port of the NMOS transistor N12 is connected to the external voltage (Vcc) line 35, and the source port of the NMOS transistor N12 is connected to the grounding voltage (Vss) line 36. When the driver 32 turns on the NMOS transistor N12 of the discharge unit 33, the static electricity transferred to the external voltage (Vcc) line 35 is transferred to the grounding voltage (Vss) line 36 via the discharge unit 33.

In brief, when static electricity is introduced through the input/output port 37, most of the static electricity flows through the diodes D2 and D3, so that a voltage drop of a few volts occurs between both sides of the diode D3 by the parasitic resistance and built-in voltage of the diode. Then, the voltage of the node “a=38 , which corresponds to the anode port of the diode D3, serves as the driving voltage of the driver 32. Herein, the cathode port of the diode D3 is connected to the external voltage (Vcc) line 35.

Accordingly, the PMOS transistor P11 of the driver 32 is turned on by the voltage of the static electricity transferred to the external voltage (Vcc) line 35, so that the NMOS transistor N12 of the discharge unit 33 is turned on. When the discharge unit 33 is turned on, the static electricity transferred to the external voltage (Vcc) line 35 is discharged to the grounding voltage (Vss) line 36 via the discharge unit 33. In this case, since the current of a few amperes is derived from the static electricity, the NMOS transistor N12 used as the discharge unit 33 must be designed to have a channel with a sufficient size.

When the electrostatic protection device shown in FIG. 3 is applied to semiconductor chips, it is possible to efficiently discharge static electricity since the discharge unit 33 operates during the entire interval where the static electricity occurs. In addition, since the circuit of FIG. 3 can minimize a factor acting as a capacitance in view of the input/output port 37, the circuit can operate actively in a high-speed operation environment.

FIG. 4 is a circuit of an electrostatic protection device according to another embodiment of the present invention.

The circuit shown in FIG. 4 includes the same components as those of FIG. 3, except that three diodes D2, D3 and D4 are connected between an input/output port and an external voltage (Vcc) line.

When it is assumed that the diodes have the same capability, although the circuit of FIG. 4 generates a voltage drop, which is twice as compared with that of the circuit of FIG. 3, a capacitance thereof is reduced to a half as compared with that of the circuit of FIG. 3, so that the circuit of FIG. 4 has an input/output capacitance smaller than that of the circuit shown in FIG. 3. The general operation of the circuit shown in FIG. 4 is same as that of the circuit shown in FIG. 3 except for the above-mentioned conditions, so repetition of the description of the same operation is omitted.

According to other embodiments of the present invention, it is possible to connect four or more diodes between the input/output port and the external voltage (Vcc) line, so the scope of the invention includes circuits having three or more diodes between the input/output port and the external voltage (Vcc) line.

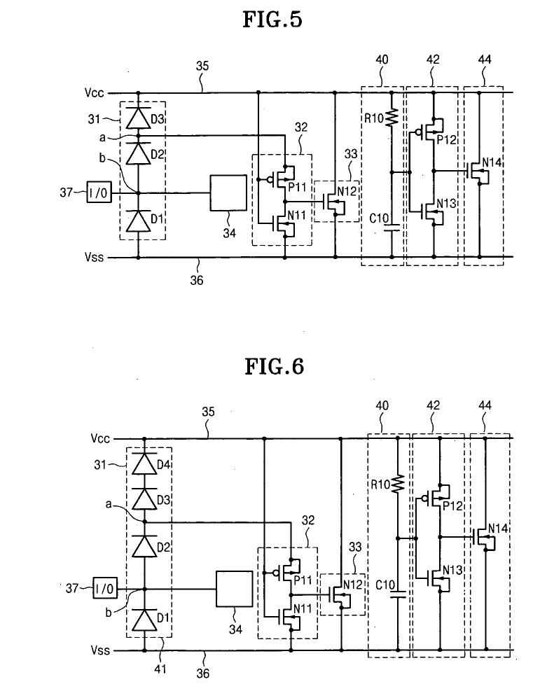

In addition, in order to provide a more efficient electrostatic discharge function during a rising interval of static electricity in addition to the circuits shown in FIGS. 3 and 4, circuits shown in FIGS. 5 and 6 may be constructed. The circuits shown in FIGS. 5 and 6 further include a control unit 40, a driver 42, and a discharge unit 44 in addition to the components of the circuits shown in FIGS. 3 and 4, respectively. In other words, the circuits of FIGS. 5 and 6 include the same components as those of FIGS. 3 and 4, respectively, except that each circuit of FIGS. 5 and 6 includes the control unit 40, the driver 42, and the discharge unit 44, so repetition of the description of the same construction and operation is omitted.

Referring to FIGS. 5 and 6, the control unit 40 includes a resistor R10 and a capacitor C10 serially connected between the external voltage (Vcc) line 35 and a grounding voltage (Vss) line 36. The driver 42 includes a PMOS transistor P12 and an NMOS transistor N13 serially connected between the external voltage (Vcc) line 35 and the grounding voltage (Vss) line 36. The discharge unit 44 includes an NMOS transistor N14 connected between the external voltage (Vcc) line 35 and the grounding voltage (Vss) line 36.

A node, which is located between the resistor R10 and the capacitor C10 in the control unit 40, is connected to both gates of the PMOS transistor P12 and NMOS transistor N13 which form the driver 42. An output port of the control unit 40, that is, a common drain port of the PMOS transistor P12 and the NMOS transistor N13 is connected to the gate of the NMOS transistor N14 forming the discharge unit 44.

According to the electrostatic protection device shown in FIGS. 5 and 6, when static electricity is transferred to the external voltage (Vcc) line 35, the static electricity is transferred to the control unit 40. Then, since the static electricity has an alternating current characteristic at an initial rising point, a voltage of the node located between the resistor R10 and the capacitor C10 is dropped. When the voltage of the node located between the resistor R10 and the capacitor C10 in the control unit 40 is dropped, the PMOS transistor P12 of the driver 42 is turned on, and subsequently, the NMOS transistor N14 of the discharge unit 44 is turned on, thereby performing electrostatic discharge for the initial rising point of the static electricity.

That is, the control unit 40, the driver 42, and the discharge unit 44 mainly perform the discharging operation at the initial rising point at which static electricity has an alternating current characteristic.

Therefore, the circuits of FIGS. 5 and 6 can operate efficiently during the entire interval where static electricity occurs.

As described above, according to the electrostatic protection device based on the present invention, the detection unit detects static electricity introduced through an input/output port, so that it is possible to discharge the static electricity during the entire interval where the static electricity is introduced. Accordingly, it is possible to stably protect an internal circuit of a semiconductor device from static electricity introduced through an input/output port and to prevent any increase in the size of the semiconductor device.

In addition, the electrostatic protection devices according to the present invention can reduce an input/output capacitance by increasing the number of serial diodes, so that the electrostatic protection device is appropriately adapted for semiconductor chips requiring high-speed operation.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An electrostatic protection device for a semiconductor device which protects a semiconductor integrated circuit from being damaged by electrostatic discharge introduced through an input/output port, the electrostatic protection device comprising:
a transfer unit for transferring static electricity introduced through the input/output port to an external voltage line, and outputting a voltage applied at a first node used for transferring the static electricity as a detection voltage;
a first driver connected between a grounding voltage line and the first node, from which the detection voltage is outputted, operated based on the static electricity transferred to the external voltage line, and driven by means of the detection voltage; and
a first discharge unit driven based on the output of the first driver in order to discharge the static electricity, which has been transferred to the external voltage line, to the grounding voltage line.

2. The electrostatic protection device as claimed in claim 1, wherein the transfer unit includes a plurality of diodes serially connected between the external voltage line and the grounding voltage line, in which the diodes are arranged such that anodes of the diodes point to the grounding voltage line, while cathodes of the diodes point to the external voltage line.

3. The electrostatic protection device as claimed in claim 2, wherein the transfer unit includes a second node connected to the input/output port, and the detection voltage is controlled by the number of diodes connected between the external voltage line and the first node which is located between the second node and the external voltage line.

4. The electrostatic protection device as claimed in claim 1, wherein the first driver includes a PMOS transistor and an NMOS transistor serially connected between the first node and the grounding voltage line, and a common gate of the PMOS transistor and the NMOS transistor is connected to the external voltage line.

5. The electrostatic protection device as claimed in claim 1, further comprising a control unit, a second driver, and a second discharge unit, which are connected in parallel between the external voltage line and the grounding voltage line,
wherein a voltage drop corresponding to an initial alternating current characteristic of the static electricity occurs in the control unit; the second driver operates based on the static electricity transferred to the external voltage line and is driven by means of the voltage drop in the control unit; and the second discharge unit is driven by means of driving voltage of the second driver so as to discharge the static electricity to the grounding voltage line in response to an initial interval of the static electricity at which the static electricity has an alternating current characteristic.

6. The electrostatic protection device as claimed in claim 5, wherein the control unit includes a resistor and a capacitor which are connected serially to each other.

7. The electrostatic protection device as claimed in claim 5, wherein the second driver includes a PMOS transistor and an NMOS transistor serially connected between the external voltage line and the grounding voltage line, and a common gate of the PMOS transistor and the NMOS transistor is connected to the external voltage line.
